(19) United States
(12) Patent Application Publication
(10) Pub. No.: US 2026/0258700 A1
(43) Pub. Date: Sep. 3, 2026

(54) System for connecting a roller blind with a fixed support structure

(71) Applicant: Plastex SA, Madonna del Piano (IT)

(72) Inventor: Marco Lombardini, Vernate (CH)

(21) Appl. No.: 19/489,914

(22) PCT Filed: Jun. 5, 2024
(86) PCT No.: PCT/IB2024/055498

§ 371 Date: Dec. 4, 2025

(30) Foreign Application Priority Data
Jun. 5, 2023 (IT) 102023000011385
Jun. 5, 2023 (IT) 102023000011388
Jun. 5, 2023 (IT) 102023000011391

(51) Int. Cl. E06B 9/42; E06B 9/58

(52) U.S. Cl. CPC E06B 9/42; E06B 9/58

(57) ABSTRACT

A system for anchoring a roller blind to a support structure such as a wall, a frame, or the like at an opening, wherein the blind has an operating end designed to be anchored to the system, includes a first and a second longitudinal half-shell, which can be mutually coupled to form a longitudinal support profile that is designed to be fastened to the support structure. The first and second half-shell are configured so that, after coupling, they form a longitudinal seat for housing the operating end of the blind.

### FIELD OF THE INVENTION

The present invention generally relates to the technical field of systems for anchoring a blind to a fixed frame, and it particularly relates to a system for connecting a roller blind to a frame.

### STATE OF THE ART

Systems for anchoring roller blinds to fixed support structures such as walls, window or door sills or jambs, or peripheral support frames specifically made at the same, are known.

Such systems, comprise a longitudinal fastening element which will be fastened to the end edges of the drape of the blind. In order to promote such fastening, the end of the drape generally comprises a thickening tubular element which will then be inserted in a corresponding seat of such longitudinal fastening element.

Prior art systems provide for a plurality of longitudinal profiles, generally made of aluminium, which are fastened to the side walls of the window by means of a plurality of screws or rivets. Such profiles are adapted to internally retain the fastening element.

Therefore, prior art blind anchoring systems firstly require the fastening of all profiles to the side walls, the subsequent sliding insertion of the fastening element and lastly the sliding insertion of the edge of the drape.

The disadvantage of such systems lies in the fact that they are complex to fit given that they require special expertise and a large number of operators to hold the profiles until all of them have been fastened.

Furthermore, prior art systems require different profiles for fitting the uprights, that is for anchoring the vertical edges of the drape, and for fitting the bases, that is for anchoring the horizontal edge of the drape.

A further disadvantage lies in the fact that the aluminium profiles need to be suitably shaped depending on the configuration of the fastening element basically making each system unique.

In other words, besides being complex and expensive, prior art systems are poorly versatile.

### SUMMARY OF THE INVENTION

An object of the present invention is to at least partly overcome the aforementioned drawbacks, by providing a system for anchoring blinds to a support structure such as a wall or frame that is highly functional and cost-effective.

Another object of the invention is to provide a blind anchoring system that is particularly versatile.

Another object of the invention is to provide a blind anchoring system which allows the anchoring thereof both vertically and horizontally.

Another object of the invention is to provide a blind anchoring system that is easy to install.

Another object of the invention is to provide a blind anchoring system that is simple to manufacture, store and transport.

Another object of the invention is to provide a blind anchoring system that allows to resist to high stresses.

Another object of the invention is to provide a blind anchoring system that can be used in environments subject to hurricanes.

These and other objects that will be more apparent hereinafter, are attained by a system for anchoring a blind to a frame as described and/or claimed and/or illustrated herein.

Advantageous embodiments of the invention are defined according to the dependent claims.

### BRIEF DESCRIPTION OF THE DRAWINGS

Further characteristics and advantages of the invention will be more apparent in light of the detailed description some preferred but non-exclusive embodiments of the invention, illustrated by way of non-limiting example with reference to the attached drawings, wherein:

FIGS. 1 to 12 show a first embodiment of an anchoring system 1, wherein:

FIG. 1 is a cross-sectional view of a first embodiment of a system 1;

FIGS. 2 and 3 are a cross-sectional view of embodiment of the system 1 of FIG. 1 in two different operating steps;

FIGS. 4 and 5 are an axonometric view of some details of the system 1 of FIG. 1;

FIGS. 6, 7 and 8 are an axonometric view of some details of the system 1 in which there is shown a fastening element 40 and a profile 10 in various assembly operating steps;

FIG. 9 is an axonometric view of some details of the system 1 in which there are shown fastening means 90, with FIG. 10 showing an enlargement of some details of FIG. 9;

FIGS. 11 and 12 show a cross-sectional view of some details of a particular embodiment of the profile 10 respectively in assembled and disassembled configuration;

FIGS. 13, 14, 15-17, 18-20, 21-23, 24, 25 and 26 are schematic views of different embodiments of the system 1;

FIG. 27 is a partially open axonometric view of a further embodiment of the system 1, with FIGS. 28 and 29 showing a cross-sectional view of the system of FIG. 27 in two different operating steps;

FIGS. 30A and 30B are a cross-sectional view of a variant of the system 1 of FIG. 27 in two different operating steps;

FIG. 31 shows a further embodiment of the system 1;

FIGS. 32 to 42 show a further embodiment of a system 1, wherein:

FIGS. 32 and 33A show an axonometric view of some details of the system 1 in two different positions;

FIG. 33B is a cross-sectional view of FIG. 33A;

FIG. 34 is an exploded view of FIG. 32;

FIG. 35 is an enlarged view of a fastening profile 85;

FIGS. 36 to 41 are a cross-sectional view of some parts of the system of FIG. 32 in different operating steps used for an upright 2;

FIG. 42 is a cross-sectional view of some parts of the system of FIG. 32 used for a base bar 3;

FIG. 43 and FIG. 44 are lateral views of different embodiments of a fastening profile 85;

FIG. 45 and FIG. 46 show a further embodiment of a system 1, in which FIG. 45 shows an upright 2 and FIG. 46 shows a base bar 3;

FIGS. 47, 48, 49 and 50 show different operating steps of a profile 10 used for obtaining a bar 3.

### DETAILED DESCRIPTION OF SOME PREFERRED EMBODIMENTS

With reference to the mentioned figures, herein described is a system 1 for anchoring a blind T preferably of the roller type to a support structure such as a wall, a window sill, a frame or the like S at an opening such as a window or a door. Suitably, the blind T may comprise a drape with an operating end T1 designed to be anchored to the system 1.

Essentially, the system 1 may comprise a longitudinal anchoring structure 10 which may be fastened to the frame or wall S.

The anchoring structure 10 may comprise or consist of at least one longitudinal anchoring profile 10.

Although in the description hereinafter reference shall be simply made to a profile 10, it is clear that the latter may be a support profile 10 consisting of a single piece (for example a single aluminium extrusion) or it may consist of two or more half-shells or profiles (for example two or more aluminium extrusions).

The profile 10 may define a main extension axis Z. Such axis Z may for example be parallel to the peripheral surface of the frame or of the wall or of the window sill.

The profile 10 may be fastened to the frame S using fastening means 90 of the per se known type. Such means 90 may for example comprise screws or rivets 91.

The longitudinal profile 10 may comprise at least one seat 13 which can be operatively connected with the operating end T1. In particular, the seat 13 may be configured to retain the end of the blind T1 and/or a fastening element 40 and/or elastic fastening means 50 as better explained hereinafter.

Preferably, the fastening element 40 may be provided for to fasten the operating end T1 with the profile 10. The fastening element 40 may be fastened to the operating end T1 and to the profile 10 so as to mutually retain the latter.

Suitably, the fastening element 40 may therefore be fastened with the seat 13. Furthermore, the fastening element 40 may comprise an operating portion 41 designed to be fastened with the operating end T1 of the blind T.

Such type of fastening is known in the industry. For example, such operating portion 41 may comprise or consist of a longitudinal seat 42 designed to house the substantially tubular-shaped end T1. In the attached drawings, there is shown a particular configuration of the seat 42 which is substantially C-shaped.

It is clear that also the fastening element 40 may have a longitudinal extension along the axis Z or an axis parallel thereto. Preferably, the fastening element 40 may extend over the entire length of the profile 10.

The fastening element 40 may be movable in the profile 10. Suitably, the latter may comprise an internal working chamber 11. The fastening element 40 may be movable in such working chamber 11. Preferably, the fastening element 40 may slide in the chamber 11 along an axis X. Preferably, such axis X may be substantially perpendicular to the axis Z.

The working chamber 11 may extend along a plane π. Preferably, the latter may be parallel to the axis Z and, more preferably it may be defined by the axis Z and by the axis X. It is clear that the plane π may therefore define a median longitudinal plane.

The profile 10 may comprise a pair of side walls 21, 22 which may remain substantially facing and parallel to the plane π so as to internally define the working chamber 11. Preferably, the profile 10 may further comprise a base wall 12 interposed between the side walls 21, 22 which may remain substantially perpendicular to the plane π.

The cross-section profile 10 may therefore have preferably, but not exclusively a substantially rectangular shape with the pair of side walls 21, 22, the base wall 12 and the upper portion 27 opposite to the latter. The upper portion 27 may be configured to allow the drape of the blind T to pass through. To this end, the portion 27 may comprise a longitudinal through opening 12′. In particular, the portion 27 may have an outer surface 27′ designed to remain exposed and an inner surface 27″ designed to remain facing towards the chamber 11.

Suitably, the fastening element 40 may slide along the axis X in the working chamber 11 between a position proximal to the base wall 12 and a position distal from the base wall 12.

Thanks to this characteristic, should the blind T be subjected to a thrust, for example due to wind, hurricane, impacts, or the like, the fastening element 40 may slide along the axis X allowing the blind T to be deformed. This will allow to prevent the breaking thereof.

It is clear that the maximum sliding of the fastening element 40 may be in the order of 5-10 cm.

According to a particular aspect of the invention there may be provided for elastic means 50 and/or 70 to counter the movement of the fastening element 40 and therefore of the blind T. In particular, the elastic means 50 and/or 70 may act along at least one sliding section of the fastening element 40 from the proximal position to the distal position.

Thanks to this characteristic, should the actions on the blind T (for example wind, impacts or hurricanes), the elastic means 50 and/or 70 mentioned above may oppose the movement of the fastening element 40 along at least one sliding section from the proximal position to the distal position, that is they may act as damping means.

Furthermore, advantageously, the elastic means 50 and/or 70 mentioned above may promote the return of the fastening element 40 towards the proximal position.

Thanks to this characteristic, the blind T may always be stretched in the absence of impacts, wind or the like.

According to a particular preferred but non-exclusive embodiment of the invention, there may be provided for elastic means 50 which may be configured to operate stretched. Suitably, such elastic means 50 may act on the fastening element 40 to counter the sliding thereof along at least one section from the proximal position to the distal position, that is to act as damping means.

In other words, such elastic means 50 may extend along at least one sliding section of the fastening element 40 from the proximal position to the distal position. Preferably, the elastic means 50 may be interposed between the fastening element 40 and the base wall 12 so as to extend when the fastening element is moved towards the distal position.

Suitably, the elastic means 50 may remain within the chamber 11. In this manner, the system 1 may be particularly compact. Preferably, the elastic means 50 may remain within the chamber 11 even when the fastening element 40 is in the maximum distal position. This will allow to prevent the fastening element 40 from exiting from the profile 10.

Furthermore, changing the elastic strength characteristics of the means 50 may allow to change the strength of the system 1 while maintaining all the other parts intact. In other words, the same system 1 may alternatively comprise different elastic means 50 so as to change the opposition action thereof on the fastening element 40 and therefore the damping action on the blind T.

According to a particular aspect of the invention, the means 50 may act along the entire sliding of the fastening element 40 or only over a sliding section thereof. In other words, the fastening element 40 may be damped over the entire sliding stroke or over a section thereof.

In this latter case, there may advantageously be a differentiated action along the sliding stroke of the fastening element 40. For example, the latter may slide freely or be opposed with reduced intensity for a section and for another section it may be opposed with high intensity.

This may advantageously allow to precisely adjust the system 1 making it adapted to different needs. For example, the opposition action along a first section may be sufficient to oppose the action of the wind and keep the blind T in position, while the action of the elastic means 50 on the fastening element 40 in a subsequent second section may be of high intensity so as to allow to withstand impacts or hurricanes.

The elastic traction means 50 may be elastically deformable between a retracted configuration and an extended configuration.

Suitably, the extended configuration of the elastic means 50 may correspond to the distal position of the fastening element 40. On the other hand, the retracted position of the elastic means 50 may correspond to the proximal position of the fastening element 40, or to an intermediate position between the proximal and distal position of the fastening element 40.

Described hereinafter are some preferred but not exclusive embodiments of the elastic means 50.

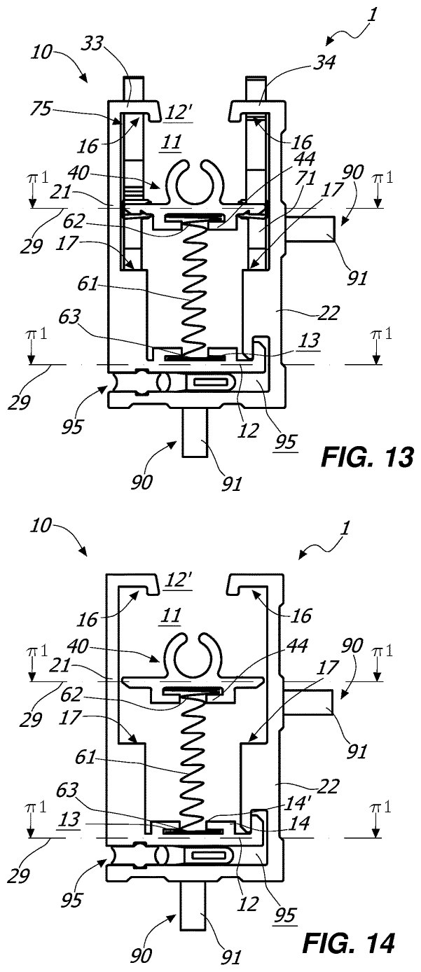

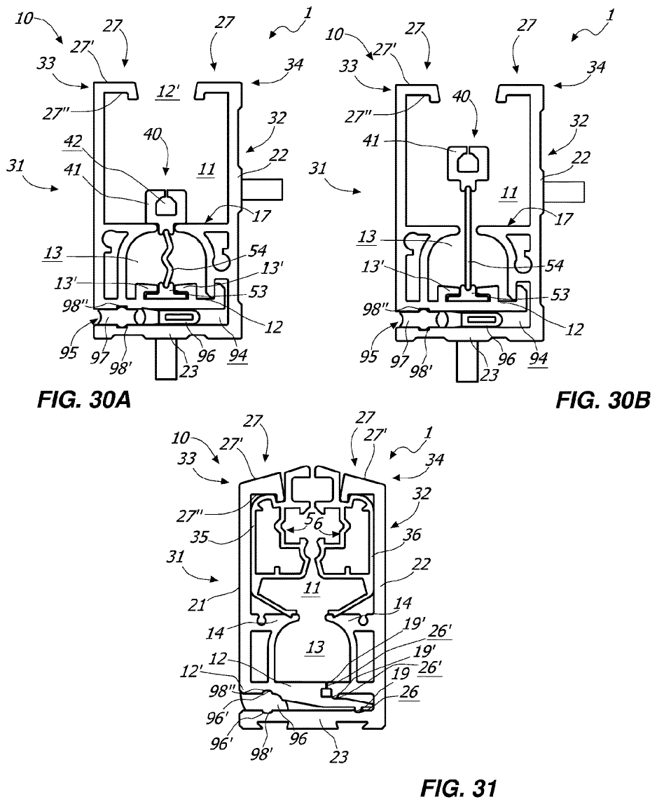

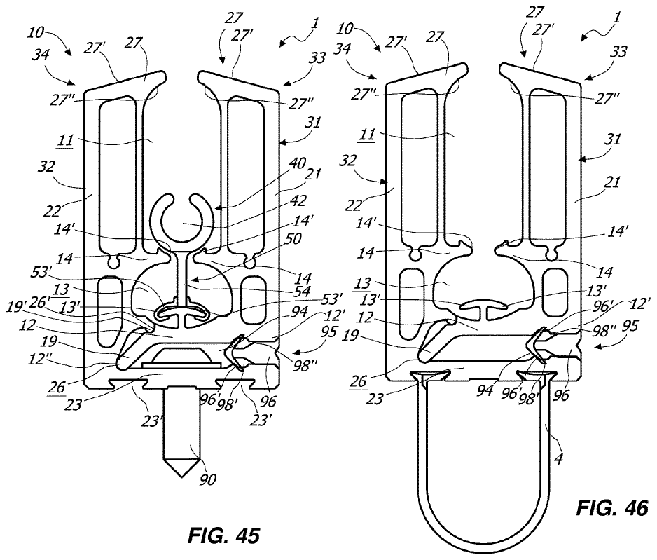

According to a particular embodiment, the elastic means 50 may act on the fastening element 40 for the entire stroke thereof from the proximal position to the distal position, for example as shown in FIG. 13, FIG. 14, FIG. 26, FIG. 30A and FIG. 30B, FIG. 45.

For example, the elastic means 50 may comprise a spiral spring 61, for example as shown in FIG. 13 and in FIG. 14. In this case, preferably, the spring 61 may act on the fastening element 40 during the entire movement between the proximal and distal position. The spring 61 may be dimensioned so as to operate by pulling to oppose the movement of the fastening element 40 from the proximal position to the distal position.

Suitably, the spring 61 may comprise a pair of opposite ends 62, 63 which may be respectively coupled with the fastening element 40 and the profile 10. In greater detail, the profile 10 may comprise a seat 13 arranged inside the chamber 11. Such seat 13 may be configured to house the end 63 of the spring 61.

Preferably, the seat 13 may be arranged in proximity of the base wall 12. For example, the latter may comprise a pair of protuberances 14 or C-shaped elements configured to retain the end 63 of the spring 61.

The movement of the fastening element 40 may correspond to the extension/to the shortening of the spring 61 and as a result to the change of the opposition action of the latter on the fastening element 40.

Suitably, the extended spring 61 may correspond to the distal position of the fastening element 40 and the unloaded spring 61 may correspond to the proximal position in which the opposition action is exerted over the entire stroke of the fastening element 40. On the other hand, as schematically shown in FIG. 13 and in FIG. 14, the unloaded spring 61 may correspond to the intermediate position of the fastening element 40. Thanks to this characteristic, the opposition action of the spring 61 on the fastening element 40 may be exerted only during the passage of the latter from the intermediate position to the distal position, that is over a section of the stroke of the fastening element 40.

Such configuration is particularly simple and cost-effective to manufacture. Furthermore, by changing the characteristics of the spring 61, in particular the elastic constant, may allow to change the intensity of the action on the fastening element 40.

According to an embodiment, the fastening element 40 and the elastic means 50 may be configured so that the latter act on the fastening element 40 for a part of the stroke thereof from the proximal position to the distal position.

This may advantageously allow to obtain a differentiated and, preferably, progressive action. For example, for a first section, the fastening element 40 may be free to slide or it may be retained with a low-intensity force, advantageous in case of low-force impacts against the blind T, and for a second section the fastening element 40 may be retained with a high-intensity force so as to resist against high-intensity impacts, such as for example in the event of hurricanes.

The elastic means 50 may comprise or consist of an element 51 made of elastically deformable polymeric material. In particular, such polymeric element 51 may be elastically deformable between a narrowed configuration and an extended configuration.

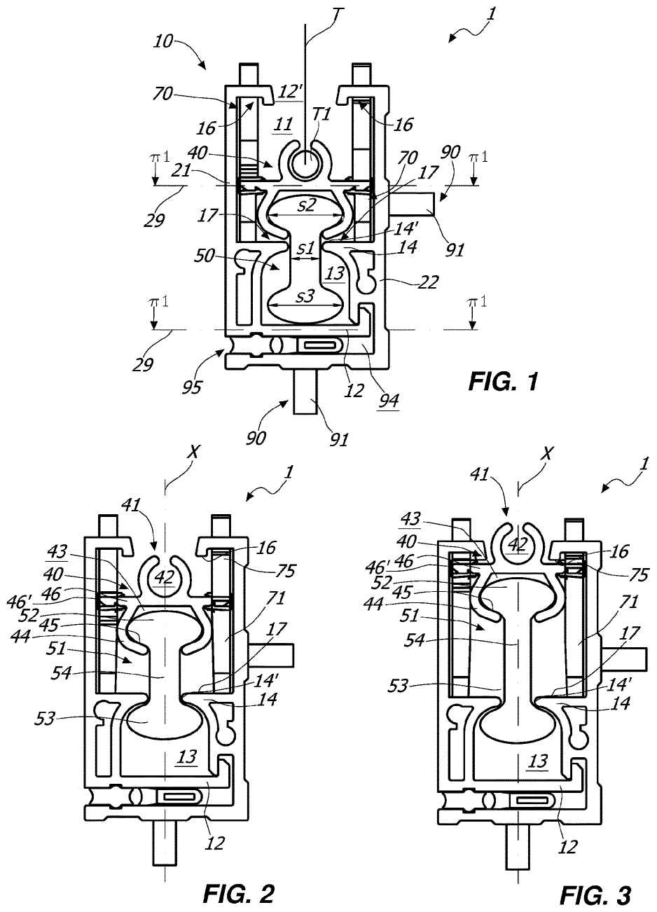

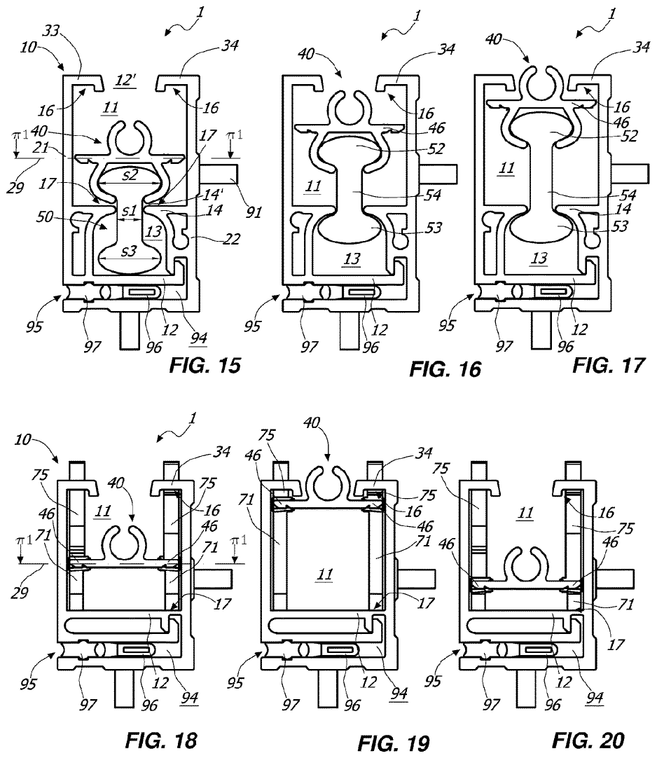

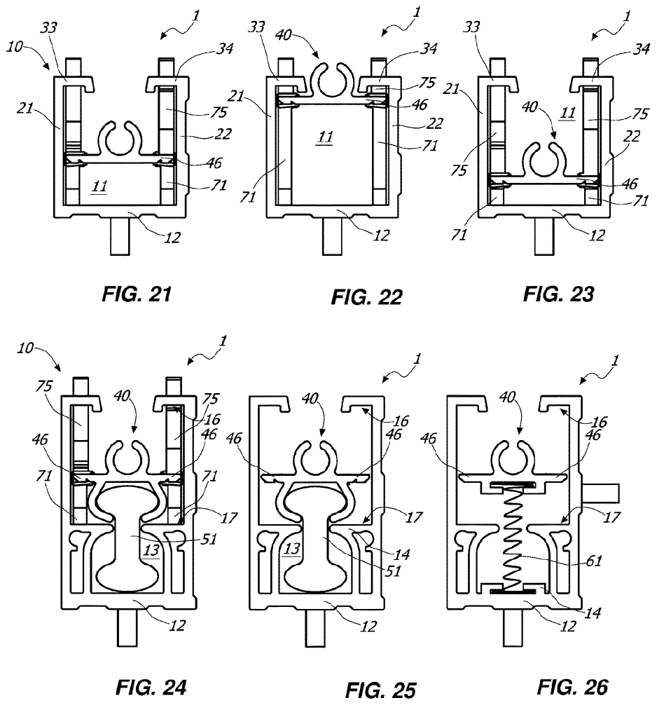

It is clear that depending on the configuration of such element 51, the elastic means 50 may act over the entire stroke of the fastening element 40, for example as shown in FIG. 30A and FIG. 30B, FIG. 45 or over a part thereof for example as shown in FIG. 1, FIG. 15, FIG. 24 and FIG. 25 and FIGS. 27-29 and FIGS. 32-41.

Suitably, the polymeric element 51 may have a pair of end portions 52, 53 which may be operatively coupled respectively with the fastening element 40 and the profile 10. Preferably, the portion 53 may be operatively coupled with the seat 13 of the latter as better explained hereinafter.

The profile 10 may comprise the seat 13 for retaining the portion 53 of the elastic element 50 when present. In the configuration in which the fastening element 40 slides for a vacant section, the portion 53 and the seat 13 may be mutually configured so as to allow the free sliding of the portion 53 in the seat 13.

In this case, preferably, the seat 13 may be formed by a pair of arched protuberances 14 facing each other. Suitably, also the arched protuberances 14 may comprise a pair of surfaces 15 adapted to come into contact with the portion 53 to retain the latter.

Advantageously, upon passing from the proximal position to the intermediate position of the fastening element 40, the element 51 may slide free. In particular, the element 51 may slide freely until the end 53 comes into contact with the abutment surface 15.

On the other hand, upon passing from the intermediate position to the distal position of the fastening element 40 the element 51 may be deform elastically, preferably extending.

Preferably, the portion 54 of the element 51 may be the one most affected by the elastic deformation. Possibly, only the portion 54 of the element 51 may be elastically deformable.

In other words, the elastic element 54 may act as a traction spring.

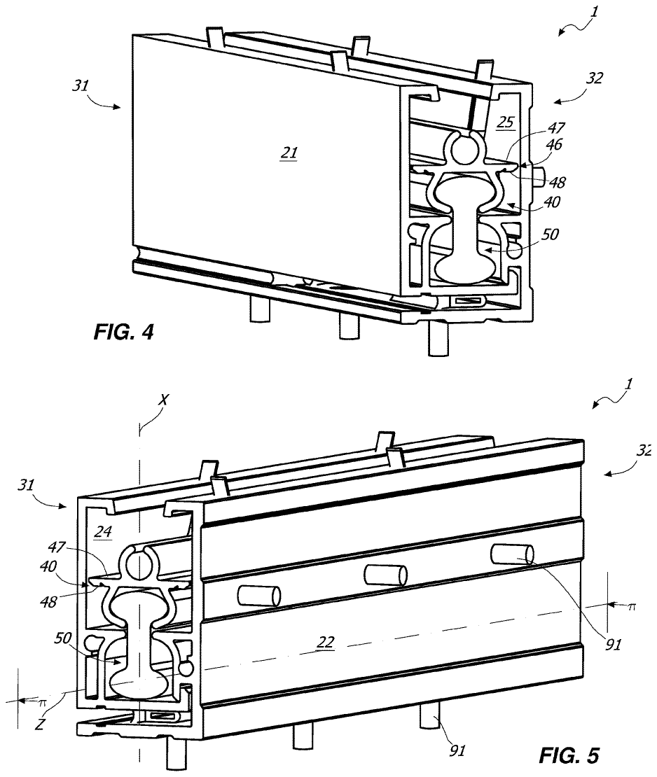

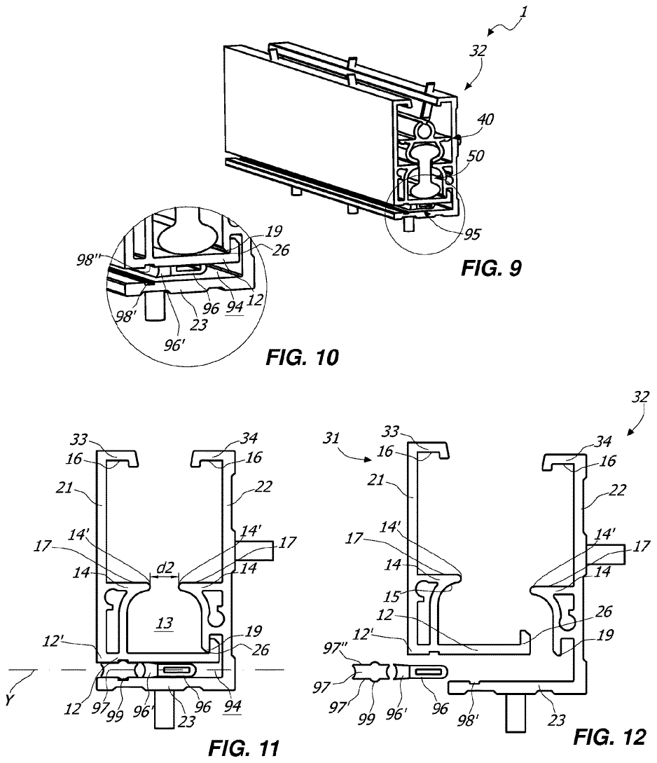

According to a particular embodiment, for example shown in FIGS. 1-12, the fastening element 40 may move for a first section from the proximal position (FIG. 1) to an intermediate position (FIG. 2) without the element 51 acting on the fastening element 40, while the latter may move for a second section from the intermediate position (FIG. 2) to the distal position (FIG. 3) opposed by the action of the element 51.

In particular, the element 51 may slide free integrally joined with the fastening element 40 for a first section of the stroke of the latter, while the passage of the fastening element 40 from the intermediate position to the distal position there may correspond the elastic deformation of the element 51 that is the passage from the narrowed configuration to the extended configuration.

Such embodiment is not exclusive. For example, the embodiments of FIG. 15, FIG. 24 and FIG. 25 and FIG. 27 have the element 51 described above which acts as a damper only for a section of the movement stroke of the fastening element 40. In particular, in figures FIG. 15, FIG. 16 and FIG. 17 the fastening element 40 is respectively in the proximal, intermediate and distal position, while in FIG. 28 and in FIG. 29 the fastening element 40 is respectively in the proximal and distal position.

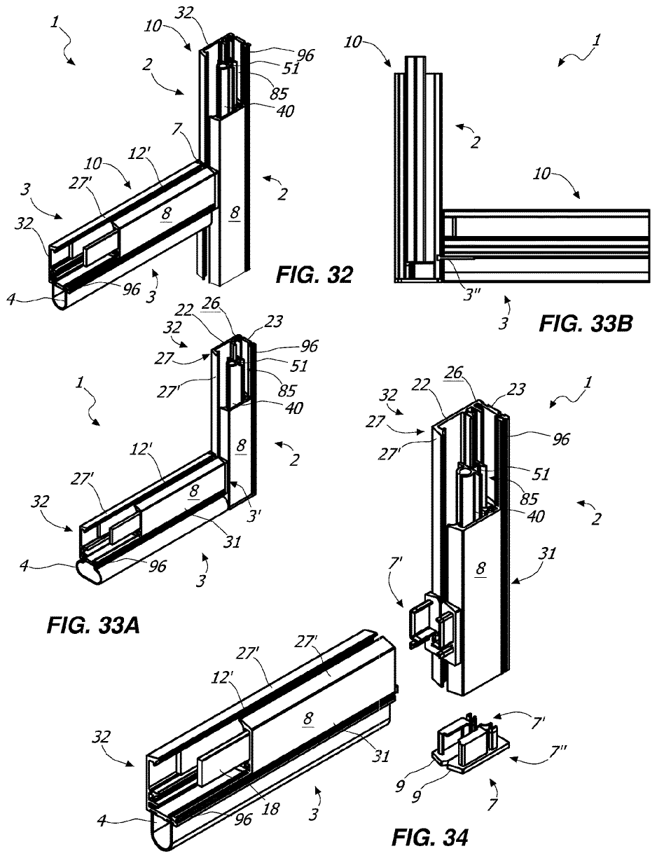

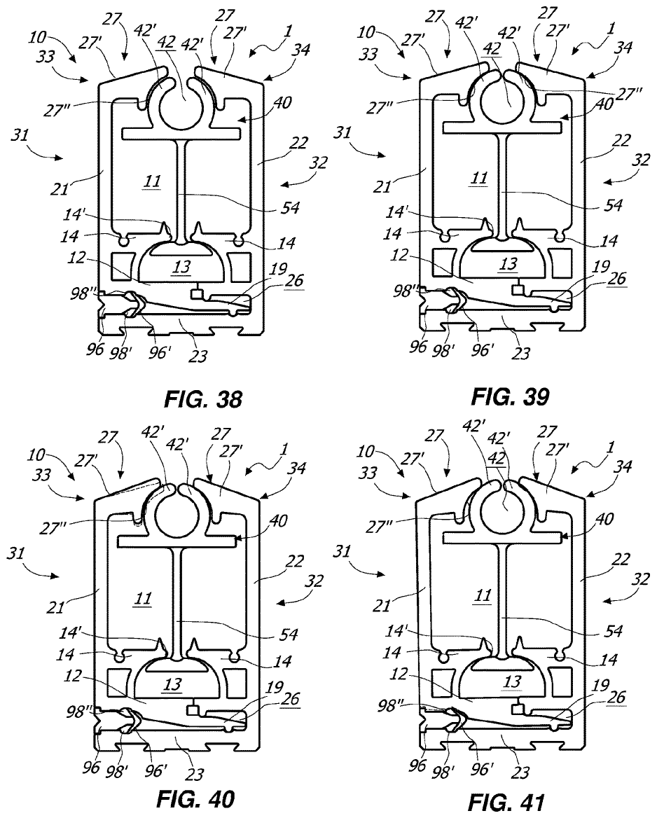

Also the embodiment shown in FIGS. 32-41 has the element 51 described above which acts as a damper only for a section of the movement stroke of the fastening element 40. In particular, in figures FIG. 36, FIG. 37 and FIG. 38 the fastening element 40 is respectively in the proximal, intermediate and distal position.

Suitably, when the elastic means 50 do not act on the fastening element 40 the latter may move freely for the first section, or, for example as shown in the embodiment of FIG. 1 and FIG. 24, the fastening element 40 may equally move damped even in the first section through further elastic means 70 different from the polymeric element 51 which will be better described hereinafter.

Irrespective of the configuration of the element 40, the element 51 may comprise the portions 52 and 53 and a portion 54 interposed between the portions 52 and 53.

As mentioned above, the portion 54 may be the portion that is elastically deformable upon the passage of the element 40 from the retracted position to the extended position.

The polymeric element 51 may have different configurations.

For example, the portion 54 may have a thickness s1 smaller than the thickness s2 and s3 of the portions 52 and 53 and the portion 54 may have a thickness s1 substantially equal to or smaller than the distance d2 between the arched protuberances 44 and/or between the arched protuberances 14.

This may advantageously allow to, the free sliding for a section of the stroke of the fastening element 40.

Furthermore, this may still advantageously allow to insert the element 51 in the fastening element 40 by sliding longitudinally, that is along the axis Z, so that the portion 52 is in the seat 43.

Possibly, for example as shown in FIG. 1 or FIG. 15, the element 51 may be bone-shaped. The arched protuberances 44 may comprise a pair of surfaces 45 adapted to come into contact with the portion 52 to retain the latter. The bone-shaped central portion 54 may be the deformable portion.

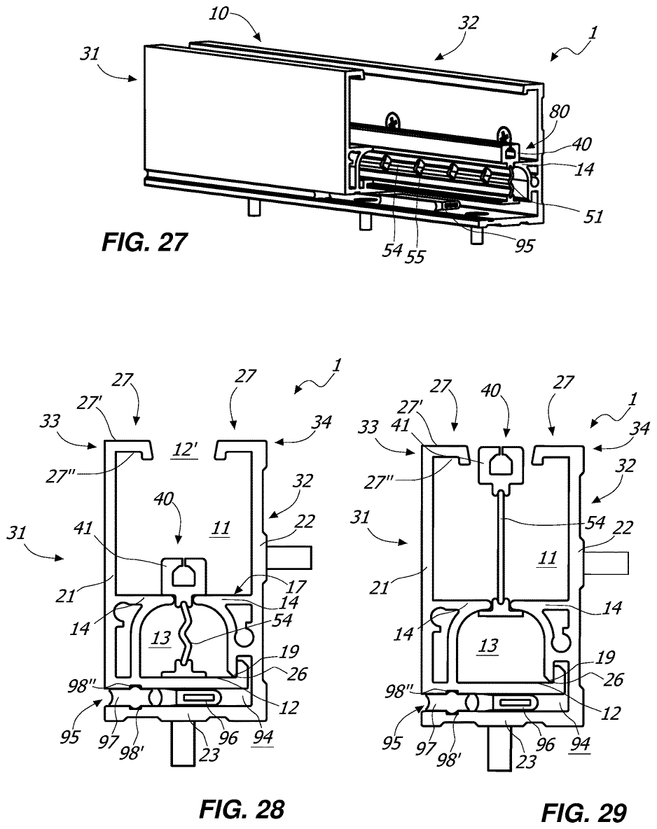

According to a particular aspect of the invention, irrespective of the configuration of the means 50, the portion 54 may have discontinuity along the axis Z. In other words, for example as shown in FIG. 27 and in FIG. 25, weakenings, grooves or openings 55 may be provided along the portion 54. Therefore, such openings 55 may weaken the resistance of the portion 54.

Therefore, advantageously the resistance of the system 1 may be changed by changing the number and/or the size of the openings 55. In this case, the system may be particularly versatile and simple to obtain given that there may be provided a single portion 54 which may therefore be die cut in a different manner depending on the needs.

Possibly, for example as shown in FIG. 30A and in FIG. 30B, the element 51 may have the central portion 54 substantially bellows-like shaped so as to facilitate the elastic extension of the central portion 54. Such bellows-like portion may be continuous or it may contain the discontinuity 55 with the advantages described above.

The element 51 and the fastening element 40 may be separate pieces.

In order to mutually couple the fastening element 40 and the elastic means 50, the fastening element 40 may comprise a seat 43 for the end 52 of the elastic means 50. For example, the fastening element 40 may comprise a pair of arched protuberances 44 that are mutually facing each other defining the seat 43 to receive the end portion 52. The latter may be substantially counter-shaped with respect to the seat 43.

According to a particularly advantageous aspect of the invention, the ends 52 and 53 may be substantially equal to each other. In this manner, both the ends 52 and 53 may be inserted into the seat 43 or into the seat 13.

On the other hand, the shaped element 51 and the fastening element 40 may be coupled stably. For example, the end 53 may be fastened with the seat 43 by gluing.

Possibly, the shaped element 51 and the fastening element 40 may be made of a single piece. Such embodiment is for example shown in FIG. 28 and FIG. 30A.

Such single piece may be obtained by co-extruding a pair of profiles, which may respectively comprise the seat 42 for the blind and the anchoring end 53, and a deformable polymeric element which may comprise or define the portion 54.

Also the embodiment shown in FIG. 32 to FIG. 41 may preferably, but not exclusively have the shaped element 51 and the fastening element 40 in a single piece. For example, there may be provided for a single polymeric profile 85. Suitably, such profile 85 may comprise both the elastic means 50 and the fastening element 40. In particular, the profile 85 may include the portion 54 and the seat 42.

Advantageously, such embodiment may have the substantially planar portion 54 which may extend elastically moving from the narrowed configuration (FIG. 37) to the extended configuration (FIG. 38). This will allow to prevent the portion 54 from impacting against the profile 10 during the continuous sliding or following very strong impacts preventing to move from the narrowed configuration to the extended configuration.

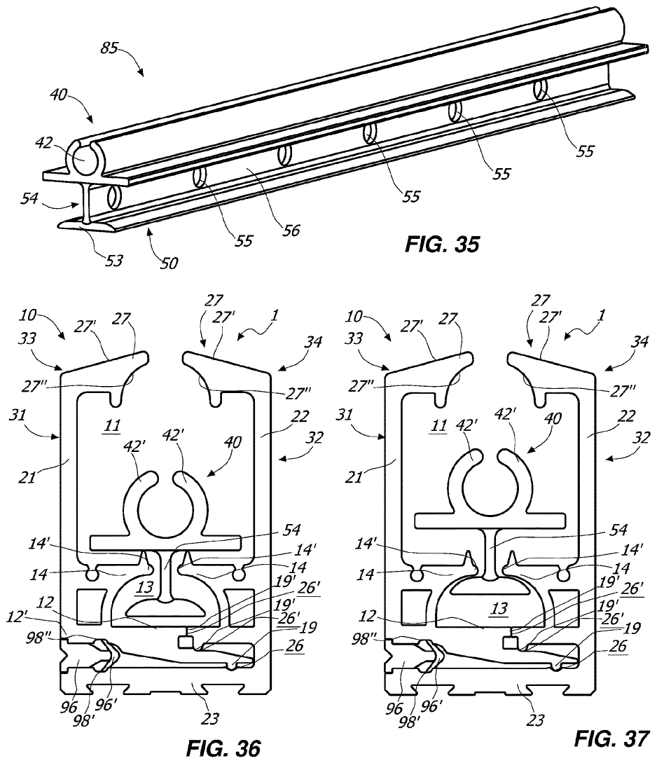

Preferably, such embodiment may have the openings 55 to adjust the intensity of the opposition action (FIG. 35). In greater detail, the portion 54 may comprise the openings 55.

According to a different embodiment, for example as shown in FIG. 43 and in FIG. 44, the elastic portion 54 may comprise a large number of openings 55 so that the empty part 55 is larger than the solid part 56. In other words, in such embodiment the portion 54 may comprise or consist of a plurality of elastic bands 56.

In this case, although the elastic element 51 may be complex and expensive to obtain, it allows to obtain a high resistance intensity precision. Furthermore, such resistance value may be replicated consistently over time.

Furthermore, such resistance value may be easily predetermined so as to be able to select the shaping of the element 51 depending on the resistance required in the system 1.

Also in this case, preferably, the elements 50 and 40 may be joined so as to define a single profile 85. In other words, different profiles 85 may be provided depending on the required resistance.

It is clear that such embodiment of the portion 54 may also be used with fastening elements 40 having different configurations.

Also the embodiment shown in FIG. 45 has a single piece 85 which comprises both the elements 50 and the elements 40. In particular, such single piece 85 has the portion 42 for anchoring to the blind and the elastic portion 54.

Despite the embodiments of FIG. 32 to FIG. 41 showing the action of the elastic means 50 on a section of the sliding stroke of the single profile 85, it is clear that a similar system in which the elastic means 50 act on the entire stroke of the profile 85 may be provided.

For example, as shown in FIG. 30A and FIG. 30B and FIG. 13 and FIG. 26 and FIG. 45, the action of the elastic means 50 may be exerted on the entire sliding stroke of the fastening element 40.

In this case, the element 51 may be constrained in an end 53 thereof with the profile 10, preferably with the seat 13.

To this end, the seat 13 may internally comprise means 13′ for fastening the end 53. Suitably, the means 13′ and the end 53 may be mutually shaped so as to be engaged.

The means 13′ may be of the female type. For example, they may comprise a pair of arched portions to internally form a seat for housing the end 53, for example as shown in FIG. 30A. The portions 13′ may preferably extend from the wall 12.

On the other hand, according to another example, the means 13′ may be of the male type, and they may for example comprise a substantially T-shaped portion with a pair of opposite protuberances 13′, while the end 53 may comprise two opposite arched portions 53′, for example as shown in FIG. 45.

In any case, the means 13′ may prevent the sliding of the end 53 along the axis X and, possibly, they may allow the sliding of the latter along the axis Z. This will allow an easy assembly and adjustments.

Preferably, the means 13′ may extend from the base part 12 or the latter may include the means 13′.

According to a particular aspect of the invention, irrespective of the presence and/or the configuration of the elastic traction means 50 described above, further elastic means 70 acting on the fastening element 40 different from the traction means 50 may be provided for.

Preferably, the means 70 may comprise elastic elements 71 configured to oppose the movement of the fastening element 40 from the intermediate position to the proximal position and/or they may comprise elastic elements 75 configured to counteract the movement of the fastening element 40 from the intermediate position to the distal position.

The elastic elements 71 may therefore facilitate the return of the fastening element 40 in the intermediate position. Therefore, advantageously, the fastening element 40 may be normally (that is without forces on the blind) maintained in the intermediate position preventing the fastening element 40 from impacting against the abutment surfaces of the profile 10, for example the surfaces 16 and 17.

Therefore, these characteristics may advantageously allow prevent the user from hearing the noise of the impact of the fastening element against the surfaces of the profile 10 which are generally made of metal and cause an annoying noise during use.

The system 1 may comprise the elastic means 70 and it may be without the elastic means 50, for example as shown in FIG. 18.

Suitably, should there be both the elastic elements 71 and the elastic elements 75, the latter may cooperate mutually to return the fastening element 40 to the intermediate position both from the distal position and from the proximal position basically acting as dampers.

It is clear that should there be the elastic elements 75 and the means 50, the elastic elements 75 may cooperate with the elastic means 50 to dampen the movement of the fastening element 40 between the intermediate position and the distal position. In this case, advantageously, the damping action may have a particularly high intensity.

In greater detail, the elastic means 70 may cooperate both with the polymeric element 51 (FIG. 1) and with the spring 61 (FIG. 13).

Described below is a preferred but not exclusively embodiment of the system 1 with the elastic means 70 which comprise the elastic elements 71 and 75 in the form of leaf springs.

The working chamber 11 may comprise an upper abutment wall 16 and a lower abutment wall 17 for the fastening element 40. In particular, the latter may slide in the chamber 11 between an upper end-of-stroke position abutting against the upper abutment wall 16 and a lower end-of-stroke position abutting against the lower abutment wall 17.

Suitably, the distal and proximal position of the fastening element 40 may correspond to the respectively upper and lower end-of-stroke position. Suitably, should there be elastic means 70, the latter may remain interposed between the fastening element 40 and the respective upper 16 and lower 17 abutment walls. Preferably, the elastic means 70 may prevent the fastening element 40 from abutting against the abutment walls 16 and/or 17 with the advantages described above.

The fastening element 40 may comprise at least one portion 46 designed to remain facing the lower 17 and upper 16 wall. Preferably, the portion 46 may be planar and it may have a longitudinal extension along the axis Z.

Preferably, the portion 46 may comprise an upper surface 47 arranged facing the upper wall 16 and a lower surface 48 facing the lower abutment wall 17.

In the absence of elastic elements 71, the upper surface 47 may abut against the upper wall 16 to define the end-of-stroke. The lower surface 48 may remain spaced apart from the lower abutment wall 17 given that the latter may act as an abutment for another portion of the element 40.

The elastic elements 71, for example the leaf springs, may be interposed between the portion 46 and the upper wall 16, preferably between the two surface 47 and the upper abutment wall 16. On the other hand, the elastic elements 75, for example leaf springs, may be interposed between the portion 46 and the lower wall 17, preferably between the surface 48 and the lower abutment wall 17.

Preferably, as shown in the attached figures, the fastening element 40 may comprise a pair of portions 46 extending on opposite sides with respect to the fastening element 40.

In this manner, advantageously, at least one pair of elastic elements 71 and at least one pair of elastic elements 75 may be provided for arranged at the pair of portions 46.

This may advantageously allow to prevent the rotation of the fastening element 40 with respect to the axis Z.

A plurality of elastic elements 71 and 75 may preferably be provided for at each of the portions 46.

Advantageously, for example as shown in FIG. 1, the protuberances 14 may comprise the lower abutment wall 17 at the upper part. Advantageously, the protuberances 14 may comprise the abutment surface 15 for the end 53 of the polymeric shaped element 51 at the lower part.

Suitably, irrespective of the configuration of the elastic means 50 and/or 70, the lower abutment surface 15 for the end 53 of the polymeric shaped element 51 may be curve-shaped. Possibly, it may be substantially counter-shaped with respect to the outer surface of the end 53. This will allow to prevent the protuberances 14 from damaging the shaped element 51.

In the light of the above, the elastic means 50 and possibly the means 70 may be deformed elastically, preferably of the portion 54 or of the spring 60, therefore forming a first step for sealing the blind T1.

For example, FIG. 36 and FIG. 37 show such first sealing step.

Irrespective of the above, and in particular of the presence and the configuration of the elastic means 50 and/or 70, the system 1 may be configured so as to provide a plurality of subsequent sealing steps.

As described above, a first sealing step may be provided by the elastic expansion of the portion 54.

Suitably, once in distal position, following the further stress by the blind T which results in a further moving away from the proximal position, the fastening element 40 may be deformed elastically, preferably by compression.

This may allow to form a second sealing step for the blind T subsequent to the first sealing step.

For example, the fastening element 40 may be deformed against the profile 10. Preferably, the fastening element 40 may deform against the abutment wall 16.

Preferably, for example as shown in FIG. 39, the profile 10 may comprise a pair of upper abutment walls 16 which may be counter-shaped with respect to the fastening element 40. In particular, the latter may comprise a pair of arched portions 42′ that are counter-shaped with respect to the walls 16.

Thanks to this characteristic, even when the fastening element 40 is elastically compressed the fastening element 40 and/or the walls 16 of the profile 10 may be protected from damage.

According to a particular embodiment, for example as shown in FIG. 39, the walls 16 and the arched portions 42′ may be mutually configured so that the further moving away of the fastening element 40 promotes the mutual approaching of the arched portions 42′.

Thanks to this characteristic, the latter may compress the end T1 preventing the latter from exiting from the seat 42. Basically, the arched portions 42′ may act as jaws.

Suitably, the inner surface 27″ of the upper portion 27 may comprise the upper abutment walls 16.

Upon the further moving away of the fastening element 40 from the proximal position, the mutual configuration of the upper walls 16 and of the arched portions 42′ may promote the deformation of the upper portion 27 of the profile.

In greater detail, the walls 21, 22 may comprise a respective upper portion 33, 34, defining the upper portion 27, which may include the upper walls 16. The deformation of the upper portion 27 may consist in moving away the respective upper portions 33, 34 of the walls 21 and 22, for example as shown in FIG. 40.

In other words, the upper portions 33, 34 and/or the walls 21 and 22 may be deformed slightly elastically.

This may allow to form a third sealing step for the blind T subsequent to the first and second sealing step.

The presence of one or more of the sealing steps for the system 1 may allow to have a very high resistance.

Preferably, the system 1 may be configured so that the deformation of the portions 27 (third sealing step) is carried out subsequently to the compression of the fastening element 40 (second sealing step) and subsequently to the extension of the portion 54 (first sealing step).

In other words, such elements may provide an incremental sealing force from the first to the third sealing step.

Thanks to this characteristic, when the action on the blind T is greater, the system 1 may have a greater sealing force allowing the blind T to resist against impacts and hurricanes.

Furthermore, advantageously, the sealing action increases in intensity as the fastening element 40 is moved away. This allows the blind T to deform slightly still retained preventing it from breaking like it would happen should the system 1 not allow such sliding of the fastening element 40.

According to a particular aspect of the invention, irrespective of the description outlined above and, in particular, irrespective of the configuration of the element 40, of the elastic means 50 and/or 70, a profile 10 that is easy particularly to install may be provided for. In particular, the longitudinal anchoring profile 10 may comprise a plurality of profiles 31, 32 coupled to each other.

Therefore, advantageously, the operations for assembling, transporting, storing and/or manufacturing the anchoring profile 10, and therefore the system 1, may be particularly simple. Furthermore, as better described below, the system 1 may be installed by a single operator.

The system 1 may comprise at least one first and one second longitudinal half-shell 31, 32. The latter, may can be mutually coupled to each other to form a longitudinal anchoring profile 10.

Similarly to the description disclosed above, the anchoring profile 10 may define a first axis Z. The latter may remain substantially parallel to the support structure S, for example in vertical or horizontal use.

The half-shells 31, 32 may therefore be longitudinal profiles having and extension along the axis Z.

Examples of anchoring profiles 10 comprising the two half-shells 31, 32 are shown in the embodiments shown in FIGS. 1-20 and in FIGS. 27-42 and FIG. 45-46.

The half-shell 32 may be fastened to the frame S using fastening means 90 which may be of the per se known type.

For example, the fastening means 90 may comprise screws 91. Preferably, the screws 91 may pass through the half-shell 32 so that the head of the screw 91 remains therein, that is on the opposite side with respect to the frame S.

Suitably, the half-shell 32 may comprise the side wall 22 and the lower bottom wall 23. Preferably, the latter may be substantially orthogonal to each other so that the half-shell 32 is substantially L-shaped.

The fastening means 90 may be positioned at the side wall 22 and/or at the lower bottom wall 23. Therefore, advantageously, the same half-shell 32 may be fastened to a horizontal or vertical wall or to both walls of the frame S.

There may therefore be provided for the fastening element 40 and the elastic means 50 and, if present, the elastic means 70 may therefore be provided for. Possibly, one or more of the latter may be pre-assembled to form an assembly 80. The latter may be easily operated by the operators.

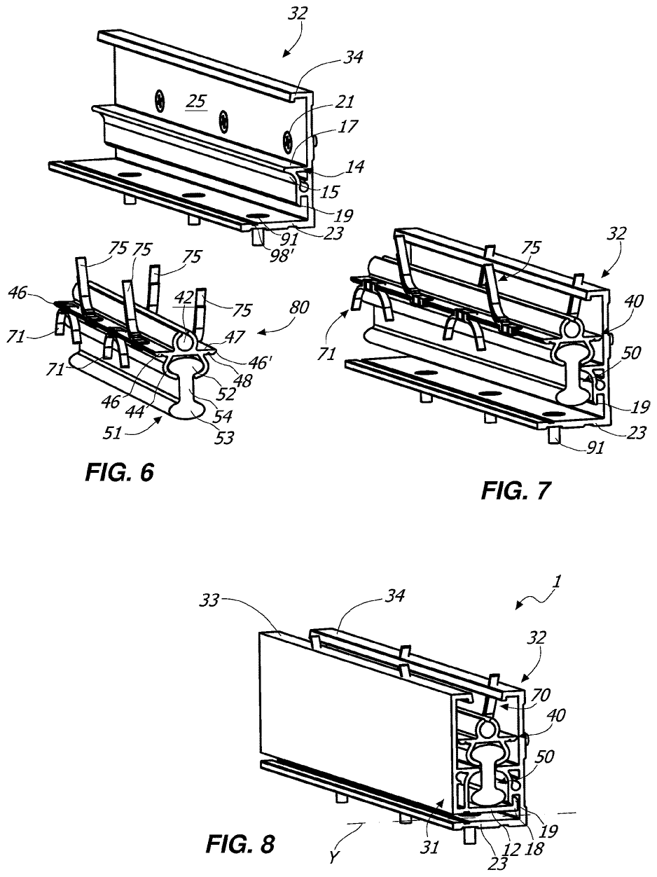

For example, as shown in FIG. 6, the fastening element 40 and the polymeric shaped element 51 may be mutually coupled so that the end 52 of the latter is inserted into the seat 43 of the former. Furthermore, the leaf springs 71 and 75 which may be fastened to the planar portions 46 of the fastening element 40 may be provided. In this case, the assembly 80 may comprise the fastening element 40, the leaf springs 71 and 75 and the polymeric shaped element 51.

On the other hand, the fastening element 40 and the elastic means 50 may be made of a single piece to form the profile 85. For example, as shown in FIG. 35 and in FIG. 45, a polymeric profile 85 which may include both the fastening element 40 and the elastic means 50, may be provided for as explained above. In this case, the assembly 80 may comprise or consist of the profile 85.

Although not shown, the assembly 80 may comprise the profile 85 and the means 70.

In any case, the use of the assembly 80 and/or of the profile 85 may allow to simplify the assembly step further.

Operatively, the half-shell 32 may be fastened to the frame using the means 90, and the assembly 80 or the profile 85 or the means 40 and/or 50 may be subsequently positioned in the half-shell 32.

The assembly 80 may be advantageously moved substantially along the axis X

Possibly, the upper abutment wall 16 may be configured to retain the leaf springs 75. For example, as shown in FIG. 7, the upper abutment wall 16 may comprise a plurality of holes designed to house the ends or the leaf springs 75.

Thanks to this characteristic, advantageously, the assembly 80 may remain in position without having to be held in position by a plurality of operators.

Subsequently, the half-shell 31 may be coupled with the half-shell 32 to form the profile 10.

Therefore, there arises the need to support the profile 10 during the assembly given that the operators will have to support a single element at a time (half-shell 32 first, assembly 80 then, and half-shell 31 lastly).

In this manner, the operations for assembling the profile 10 may be particularly simple and quick.

Furthermore, such system 1 may be installed by a single operator.

Irrespective of the above, the half-shells 31, 32 may be mutually configured so that once coupled they form the operating chamber 11 therein.

Such operating chamber 11 may therefore be configured to house the fastening element 40 and the elastic means 50 and possibly to allow the sliding thereof in the operating chamber 11 as described above. Suitably, should there be provided for the assembly 80 or the profile 85, the latter may slide in the operating chamber 11 as described above.

Preferably, the half-shells 31, 32 may be mutually configured so that once coupled they form the longitudinal seat 13 to operatively anchor the operating ends T1 of the blind T.

The expression operatively anchor is used to indicate that end T1 may be fastened in the seat 13 so as to be retained therein, or fastening elements 40 and/or elastic means 50 that may act as operative connection between the seat 13 and the end T1 may be provided for as described above. Depending on the configuration, as described above, the means 50 may have an end 53 slidable in the seat 13 or fastened in the seat 13, for example using the means 13′.

Suitably, the half-shells 31, 32 may each comprise at least one operating shaped area 5, 6. In particular, the latter may be mutually configured so that once coupled the half-shells 31, 32, the zones 5, 6 cooperate with each other to form the chamber 11 and/or the seat 13.

In greater detail, the half-shells 31, 32 may include a respective first and second wall 21, 22 designed to remain substantially facing each other in use.

The walls 21 and 22 may internally include operative areas 5, 6 so that once coupled the half-shells 31, 32, the areas 5, 6 are arranged facing each other. In particular, each of the latter may comprise at least one longitudinal protuberance 14 extending towards the other of the walls 21, 22.

Such longitudinal protuberances 14 may be mutually configured so that once coupled the half-shells 31, 32 the protuberances 14 cooperate to form the seat 13.

The walls 21 and 22 same case applying to the protuberances 14 may have one of the configurations described above. However, it is clear that the system may comprise protrusions 14 shaped differently.

Preferably, the protuberances 14 may partition the chamber 11 into a lower area defining the seat 13 and into an upper area within which the fastening element 40 slides.

The latter configuration is particularly advantageous given that it simplifies the operations for installing the system 1. Such configuration further simplifies the installation of the system 1 should there be provided for the assembly 80 or the single profile 85.

In this latter case, the assembly 80 or the single profile 85 may have a portion in the lower area 13 and a portion in the upper area of the chamber 11.

Furthermore, suitably, upon coupling the half-shells 31, 32, the protuberances 14 may be configured so as to form a gap d2 between them. The elastic means 50, in particular for the portion 54 of the element 51 may be arranged in such gap. In greater detail, the protuberances 14 may extend from the side walls 21, 22 of each of the half-shells 31, 32 so that the ends 14′ of the protuberances 14 are arranged facing each other and spaced apart by the distance d2. Such distance d2 may be substantially equal to the thickness s1 of the portion 54 of the shaped element 51.

Advantageously, the portions 14 may further comprise the lower abutment walls 17 for the elastic elements 71, for example the leaf springs 71.

It is clear that the portions 14 may be shaped differently depending on the configuration of the seat 13. For example, should there be a spring 61, the portions 14 may be close to the bottom wall 12 and they may form a seat for retaining a seat to retain the spring 61.

Each half-shell 31, 32 may comprise an upper portion 33, 34. Suitably, the upper portion 27 of the profile 10 may therefore comprise such upper portions 33, 34.

The upper portions 33, 34 may be substantially transverse with respect to the side wall 21, 22. This may allow to internally define the chamber 11. In other words, the upper portions 33, 34 may have an extension substantially parallel to the base wall 12.

Upon coupling the half-shells 31, 32, the upper portions 33, 34 may be remain mutually facing each other and spaced apart so as to form the opening 12′ for the blind T.

Suitably, the upper portions 33, 34 may be configured so that the outer surface 27′ is substantially perpendicular to the side wall 21, 22, for example as shown in FIG. 1.

Such aspect is not exclusive. As a matter of fact, the upper portions 33, 34 may be configured so that the outer surface 27′ is substantially inclined with respect to the side wall 21, 22, for example as shown in FIG. 36.

In any case, the upper portion 33, 34 may have an inner opposite face 27″ which may remain substantially parallel to and arranged facing the portion 46 of the fastening element 40. Such surface 27″ may comprise the upper abutment walls 16.

According to a particular aspect of the invention, the system 1 may comprise one or more substantially continuous areas 29 which extend in a plane π1 that is substantially perpendicular to the plane π. Such areas 29 may confer a structural resistance against the stresses along such plane π1 therefore defining the reinforcing areas 29.

The lower portion 28 of the profile 10 may comprise a reinforcing area 29. For example, the lower wall 12 may extend between the side wall 21 and the side wall 22 therefore defining the reinforcing area 29.

On the other hand, several walls and/or appendages which may cooperate with each other to define the reinforcing area 29 may be provided for. For example, in the embodiments of the invention which comprise the profile 10 made of two half-shells 21, 22, for example as shown in FIG. 1, the lower portion 28 may comprise the wall 12 which may interact with a part of the half-shell 22. Furthermore, the latter may comprise another wall 23 extending over the entire width of the profile 10.

In the latter case, the lower portion 28 may comprise a pair of areas 29 facing each other.

The side walls 21, 22 or the half-shells 21, 22 may cooperate with the shaped element 40 to define a reinforcing area 29. In particular, the planar portions 46 may have a width such that the respective ends 46′ are close to or in contact with the inner surface 24, 25 of the side walls or half-shells 21, 22.

In this case, the two reinforcing areas 29 may therefore define two planes π1 that are substantially parallel and spaced with respect to each other. This may advantageously allow to prevent the walls 21, 22 from mutually approaching each other.

Such aspect may be particularly significant and in the case of the profile 10 it comprises two half-shells 31, 32 and in particular should the rotation of one of the half-shells 31, 32 result in the de-coupling of the two half-shells 31, 32.

According to a particular aspect of the invention, irrespective of the description outlined above and, in particular, irrespective of the configuration of the element 40, of the elastic means 50 and/or 70, and irrespective of the configuration of the inner areas 5, 6 and/or of the seat 13 or of the chamber 11, the profile 10 may be formed by a pair of half-shells 31, 32 configured so that once coupled they form a gap 94 between them.

As better described below, such configuration allows to couple the half-shells 31, 32 in a particularly simple manner and at the same time ensure a high mechanical strength to the system.

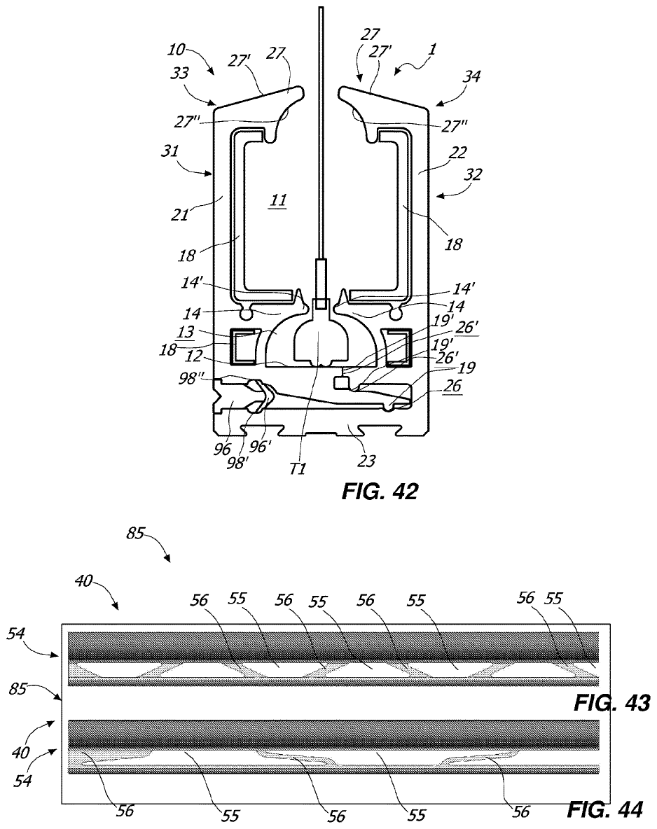

Examples of such profile 10 are shown in FIG. 1-12, FIG. 13, FIG. 14, FIG. 15-17, FIG. 18-20, FIG. 27-29, FIG. 30A-30B, FIG. 31, FIG. 32-41, FIG. 42, FIG. 45 and FIG. 46.

In greater detail, the half-shell 31 may be positioned so that the wall 21 of the latter is arranged facing the wall 22 of the half 32 and so that the lower wall 12 is arranged facing and spaced apart from the wall 23.

Essentially, the profiles 31 and 32 may each comprise an area 19, 26 designed to be mutually engaged to rotate with respect to each other.

According to an embodiment, the half-shells 31, 32 may be coupled slidably. Such movement is particularly simple and it allows an easy assembly.

In greater detail, the half-shell 31 may be moved along the axis Y (perpendicular to the axis X and Z) and subsequently along the axis X so that the appendage 19 is engaged in the groove 26. Such movement is schematically shown in FIG. 11 and FIG. 12. Similar embodiments are shown in FIGS. 13-20 and FIGS. 27-30B.

Preferably, the lower wall 12 may comprise a male element 19 designed to be inserted into a corresponding seat 26 of the half-shell 32. In greater detail, the male element 19 may be an appendage arranged at the vacant end of the wall 12 and extending perpendicularly to the wall 12. On the other hand, the seat 26 may be a groove substantially perpendicular to the lower wall 23.

In any case, upon engaging the appendage 19 in the groove 26, the walls 12 and 23 may remain mutually spaced apart to form a gap 94. This characteristic may allow to perform the movements of the half-shell 31 described above.

Preferably, the distance between the walls 12 and 23 may be substantially equal to or slightly larger than the length of the appendage 19.

On the other hand, according to a different embodiment, the coupling between the half-shells 31, 32 may be carried out by rotation. Examples of such embodiments are shown in FIG. 31 and in FIGS. 36-42 and in FIGS. 45-46.

The coupling by rotation may be even simpler in that the operator may for example, position the appendage 19 in the seat 26 so that the weight of the half-shell 31 is supported by the half-shell 32 and it may simply rotate the half-shell 31 with respect to the seat 26 to place it in position.

Also in this case, upon engaging the appendage 19 in the seat 26, the walls 12 and 23 may remain mutually spaced apart defining the gap 94. This characteristic may allow to mutually rotate the half-shell 31 and 32 with respect to the seat 26.

In greater detail, this will allow to define a rotation pivot so that the operator can couple the profiles 31, 32 by rotating around an axis substantially parallel to the axis Z.

For example, one of the profiles may comprise a female seat 26 while the other of the profiles may comprise a male element 19. The male element 19 and the female seat 26 may rotate mutually.

This may allow to move the half-shell 31 until the male element 19 and the seat 26 are engaged, and the half-shell 31 may be rotated subsequently.

Thanks to this characteristic, the coupling may be obtained simply even when the half-shell 32 has already been fastened with the frame.

The male and female elements 19 26 may have different configurations.

For example, the base wall 12 may comprise an end defining the male element 19 while the base wall 23 may comprise a concave area defining the seat 26.

Suitably, the end 19 may be configured so that upon coupling the half-shells 31, 32 the wall 12 has an area 12′ spaced from the wall 23 and an area 12″ in contact with the wall 23. The end 19 may include or define the area 12″.

This may allow the rotation between a configuration in which the area 12′ is close to or in contact with the wall 23, not shown in the figures, and a configuration in which the area 12′ is spaced apart from the wall 23, shown in FIGS. 31-46.

Preferably, irrespective of the configuration of the elements 19 and 26 (and translation or rotary coupling as a result), the half-shells 31 and 32 may be configured so as to comprise a respective further contact area 19′ and 26′.

Such areas 19′ and 26′ may define the end-of-stroke of the mutual movement. In other words, the operator may move the half-shells 31 and 32 until the areas 19′ and 26′ are in contact. Such configuration may correspond to the one in use in which the walls 21 and 22 may be arranged facing each other.

Furthermore, the areas 19′ and 26′ designed to abut against each other may allow to prevent the walls 21 and 22 from approaching each other during use, therefore providing high rigidity to the system 1.

The areas 19′ and 26′ may have different configurations.

Preferably, but not exclusively, they may be a male-female element. Preferably, the areas 19′ and 26′ may be on the opposite side with respect to the gap 94.

For example, FIG. 45 shows the half-shell 32 with an appendage 19′ and the base wall 12 with a concave area 26′. On the other hand, FIG. 36 shows the base wall 12 with a concave area 26′ and a flat surface 26′ and the half-shell 32 with an appendage 19′ form the concave area and a flat surface 19′ for the flat surface 26′.

In the example of FIG. 12, there may be provided for the surfaces 19′ and 26′.

According to a particular aspect of the invention, advantageously, the male 19 and female elements 26, and possibly the areas 19′ and 26′ may be external to the chamber 11. For example, they may be arranged at the lower part with respect to the axis X, the seat 13 preferably below the wall 12.

In other words, advantageously, the easy coupling of the profiles 31, 32 described above may be obtained irrespective of the configuration of the chamber 11, of the seat 13, of the operative areas 5, 6, and therefore of the fastening element 40, of the elastic means 50 and/or of the end of the blind T.

As described above, upon coupling the half-shells 31, 32 so that the walls 21, 22 are arranged facing each other and substantially parallel, the base walls 12 and 23 may remain mutually spaced apart, that is a gap 94 may be formed. As a matter of fact, the latter allows the mutual movement of the half-shells 31, 32 (slidably or rotatably) as described above.

Suitably, fastening means 95 may therefore be provided to prevent the approaching of the walls 12 and 23 and therefore the disengagement of the element 19 and of the seat 26. In particular, depending on the configuration, the fastening means 95 may prevent the rotation or the mutual sliding of the half-shells 31 and 32.

The gap 94 may be formed between the base walls 12 and 23 of the half-shells 31, 32. Preferably, the gap may be formed between the area 12′ and the wall 23. Such characteristic is particularly advantageous should the rotary coupling in which it is not necessary that the whole wall 12 remains spaced apart from the wall 23.

The fastening means 95 may be positioned in such gap 94 so as to prevent the mutual movement of the walls 12 and 23 (rotation and translation) and therefore the disengagement of the male and female elements 19, 26.

Such fastening means 95 may comprise or consist of a spacer 96.

The spacer 96 may have a longitudinal extension along the axis Z with a width along such axis substantially equal to the length of the profile 10, that is it may also be a longitudinal profile, or it may have a significantly small width, in the order of a few centimetres. In this case, there may be provided for a plurality of spacers 96 arranged along the profile 10.

Preferably, the spacer 96 may be fully or partially made of polymeric material, preferably made of elastomeric material.

Suitably, the spacer 96 may be at least partially substantially wedge-shaped so as to facilitate the insertion thereof into the gap 94 between the walls 12 and 23.

The wedge-shaped portion 96′ of the spacer 96 may have a thickness larger than the gap 94. In this manner, upon inserting the spacer 96 into the gap 94, the former may force the walls 12 and 23 to keep them spaced apart.

Such aspect may be particularly advantageous given that it allows to keep the walls 12 and 23 spaced apart even in the presence of small dimensional changes between the parts of different profiles 10, the so-called tolerances.

A cap 97 for preventing the removal of the spacer 96 from the interspace 94 may be possibly provided for, for example as shown in FIG. 12.

Possibly, such cap 97 may keep the walls 12 and 23 separated also acting as a spacer or cooperating with the spacer 96. For example, the cap 97 may have a thickness equal to the thickness of the spacer 96.

Preferably, the spacer 96 may have a length smaller than the wall 12 and/or the wall 23. The cap 97 may therefore be inserted into the gap 94 subsequently to the spacer 96.

Suitably, the cap 97 or the spacer 96 may have a relief 99 at least one of the lower 97′ and upper 97″ surfaces, preferably of both surfaces 97′, 97″.

On the other hand, the wall 23 and the wall 12 may comprise a respective longitudinal groove 98′ 98″.

The distance between the reliefs 99 may be greater than the height of the gap 94. The cap 97 may be forced into the gap 94 until the reliefs 99 are at the respective grooves 98′ 98″.

This may advantageously allow to prevent the cap 97 from exiting from the gap 94. Furthermore, the cap 94 may maintain the spacer 96 in the gap 94.

According to a different embodiment, for example as shown in FIGG. 36-41, FIG. 42, FIG. 45 and FIG. 46, the wedge-shaped portion 96′ of the spacer 96 may be inserted so as to remain at the longitudinal grooves 98′ 98″ of the wall 23 and of the wall 12.

For example, there may be provided for a pair of fins 96′ arranged on opposite sides with respect to the spacer 96. The fins 96′ may interact with the seats or grooves 98′ and 98″.

Therefore, advantageously, it will not be necessary to use a cap 97 and this will simultaneously allow to prevent the spacer 96 from exiting.

Preferably, the spacer 96 may be arranged between the area 12′ and the wall 23. Therefore, the spacer may be the furthest possible from the seat 26′ that is from the rotation pivot.

In the light of the above, the rotation of the half-shell 31 with respect to the half-shell 32 may be prevented both in the clockwise and anticlockwise direction, and the half-shell 31 may be prevented from sliding with respect to the half-shell 32 along the axis X. In other words, the appendage 19 and the seat 26 may be prevented from being disengaged.

In greater detail, for example with reference to FIG. 45, the anticlockwise rotation of the shell 31 may be prevented by the areas 19′ and 26′ which end up in abutment, while the clockwise rotation of the spacer element 96 may be prevented or predetermined by elastically compressing the spacer element 96.

The elements 19 and 26 and/or areas 19′ and 26′ may further prevent the mutual approaching of the shells 31 and 32 along the axis Y.

The fastening means 95 may further prevent the mutual moving away of the shells 31 and 32 along the axis Y. For example, the wedge-shaped portions 96′ of the spacer 96 may interact with the grooves 98′ 98″ to prevent such moving away.

Suitably, in the light of the above, the half-shells 31, 32 may be coupled stably without deformations or interference, therefore ensuring high resistance of the system in use.

According to a particular aspect of the invention, the spacer 96 may be slightly elastically compressible so as to form a sealing step. In other words, the spacer 96 may have a predetermined yield ability so as to be elastically compressed once subjected to a predetermined stress.

Suitably, the fastening element 40, upon reaching the distal position, when further moved away from the base 12 may promote the moving away of the upper portions 27 of the walls 21 and 22 and therefore the rotation thereof and the compression of the spacer 96 as a result. The latter may therefore act as a compressible elastic element.

Should the system 1 be configured as described above with the elastic portion 54 and/or the deformable portion 27 and/or the compressible fastening element 40, the system may be configured so that the deformation of the spacer 96 (fourth sealing step) occurs only subsequently to the deformation of the portions 27 (third sealing step) and the compression of the fastening element 40 (second sealing step) and the extension of the portion 54 (before the sealing step).

In other words, such elements may provide an incremental sealing force from the first to the fourth step.

Thanks to this characteristic, the system 1 may have a sealing strength that is even greater and simultaneously gradual.

According to a particular aspect of the invention, irrespective of the description outlined above there may be provided for a system 1 adapted to anchor different ends T1 of the same blind T, for example vertical and horizontal sections, and/or different ends T1 of different blinds T.

In particular, the system 1 may comprise at least one anchoring profile 10 which may be configured to anchor such different ends T1 of the drape of the blind T.

Advantageously, the anchoring profile 10 may be installed both vertically, that is to form an upright 2 to laterally guide the blind and allow the vertical sliding thereof, and horizontally, that is to define the so-called base bar 3.

Thanks to this characteristic, the system 1 may be particularly versatile.

The anchoring profile 10 may preferably, but not exclusively be obtained using half-shells 31, 32 as described above.

In greater detail, depending on the configuration of the operative portions 5, 6 there may be formed operative seats 13 and chambers 11 having different configurations which may therefore be adapted to ends T1 and/or to fastening elements 40 and/or different elastic means 50.

Preferably, the vertical lateral ends T1 of the blind may be fastened to the uprights 2 by using fastening means 40 and/or means 50 as described above.

Advantageously, there may be used the same half-shells 31, 32 for anchoring the fastening elements 40 or means 50 so as to form the uprights 2 for vertically guiding the blind T, and the lower end T1 of the blind, so as to form the base bar 3.

In other words, the profile 10 may be used as an upright 2 or bar 3. Advantageously, this may allow to reduce the manufacturing and storage costs. The installation technicians may simply procure a profile 10, for example with a pair of half-shells 31 and 32 which they may be use as an upright or bar depending on the needs on site.

For example, FIG. 36 and FIG. 42 show an upright 2 and a bar 3 which use the same half-shells 31, 32. Similarly, FIG. 45 and FIG. 46 show an upright 2 and a bar 3 which use the same half-shells 31, 32.

In this case, advantageously, the seat 13 may be configured to house the horizontal lower end T1 of the blind to form the bar 3 (FIG. 46 and FIG. 42) and the vertical lateral end T1 of the blind, for example using a profile 85 (FIG. 45 and FIG. 36).

It is clear that to this end the seat 13 may have a height along the axis X such to house the profile 85 and the horizontal lower end T1. The protuberances 14 may therefore have a distance d2 slightly greater than the thickness of the blind so as to retain the profile 85 (or the assembly 80, or the end 53 or the profile 40 depending on the configurations) and the lower end T1.

Furthermore, should the profile 10 be made using the half-shells 31 and 32 and should the latter be fitted rotatably or slidably as described above, both the upright 2 and the bar 3 may be fitted easily. As a matter of fact, the “front” fitting described above (slidably or rotatably) allows to prevent the sliding of the lower end T1 and of the profile 85 along the profile 10, that is along the axis Z.

On the other hand, according to a particular embodiment of the invention, the system may further comprise further longitudinal profiles 35, 36. The latter may be coupled with the half-shells 31, 32 respectively. Preferably, a profile with a half-shell 31-35 and 32-36. For example, FIG. 31 shows a cross-sectional view of a support profile 10 which comprises the half-shells 31, 32 and the profiles 35, 36.

Suitably, the longitudinal profiles 35, 36 may comprise at least one longitudinal protuberance 35′ 36′. The latter may be mutually configured so that once coupled the half-shells 31, 32 cooperate to form the seat 13. In other words, such longitudinal protuberances 35′ 36′ may define the operating shaped area 5 and 6.

In greater detail, the longitudinal profiles 35, 36 may comprise an outer face 37′ and 38′ and an inner face 37″ and 38″. Upon coupling the profiles 35 and 36 with the half-shells 31 and 32 and once the latter are coupled to each other, the inner faces 37″ and 38″ may be arranged facing each other.

Preferably, the longitudinal protuberances 35′ 36′ may extend from the inner faces 37″ and 38″ of the longitudinal profiles 35, 36.

Possibly, the outer faces 37′ and 38′ may be arranged facing the wall 21 and 22 of the half-shells 31 and 32.

Suitably, a pair of half-shells 31, 32 and at least one first and second pair of profiles 35, 36 which may have the differently shaped longitudinal protuberances 35′ 36′, may be provided for. This may advantageously allow to form differently shaped seats 13 by coupling differently shaped profiles 35, 36.

Therefore, advantageously, a system having the same half-shells 31, 32 and different profiles 35, 36 which may be adapted for different ends T1 of the same blind and/or of different blinds, may be provided.

On the other hand, the profiles 35, 36 may be cost-effective and of poor in aesthetic appeal, for example they may not be finished, given that they may remain concealed from view. Preferably, the profiles 35, 36 may be made of plastic.

Suitably, the half-shells 31, 32 may be suitable to be coupled removably. This may allow to simplify operations for the maintenance and replacement thereof.

For example, the half-shells 31, 32 may have a male or female element 19 which can be snap-engaged with a corresponding female or male element 26 of the other half-shell 31, 32. The male and female elements 19, 26 may be mutually configured so that once mutually engaged they prevent the mutual moving away of the half-shells 31, 32 along a direction substantially perpendicular to the axis Z.

FIG. 32 show a support profile 10 which comprises the pair of half-shells 31, 32 described above and a pair of profiles 35, 36 which are coupled with the half-shells 31, 32.

Such embodiment may be particularly adapted to form a base 3.

It is clear that depending on the configuration of the profiles 35, 36 different seats 13 may be formed starting from the same half-shells 31, 32.

As a matter of fact, the configuration described and shown above is provided solely by way of embodiment and changing the shaping of the profiles 35, 36, for example of the inner faces 37′ and 38′ may allow to obtain different seats 13.

Suitably, the system 1 may comprise three pairs of half-shells 31, 32 identical to each other, two of them may form the uprights 2 and one may form the base bar 3.

On the other hand, should the system 1 provides for using inner profiles 35, 36, the system may comprise three pairs of half-shells 31, 32 which are identical to each other and a pair of longitudinal profiles 35, 36. In particular, the pair of longitudinal profiles 35, 36 may be inserted into a pair of half-shells 31, 32 to form the base bar 3 while the other two pairs of half-shells 31, 32 may form the uprights 2.

Advantageously, the uprights 2 may be positioned vertically facing each other, while the base bar 3 may be horizontal. Preferably, the bar 3 may be slidable along a direction parallel to the uprights 2. More preferably, the end 3′ of the bar 3 may interact with the uprights 2 so that the former is guided in sliding by the latter.

It is clear that the sliding of the bar 3 may correspond to the sliding of the blind T, that is the unwinding and winding thereof in case of roller blinds.

Suitably, the half-shells 31, 32 may have respective ends 31′ and 32′ designed to remain mutually facing and spaced apart with respect to each other. This may allow to form the opening 12′ between the ends 31′ and 32′.

Possibly, caps 7 coupled to the bar 3 which may therefore comprise the operating ends 3′ designed to interact with the uprights 2 may be provided for.

The caps 7 may have a portion 7′ designed to be inserted into the profile 10 and an opposite portion 7″ designed to interact with the uprights 2.

Suitably, the portion 7″ may comprise a pair of converging surfaces 9 that are counter-shaped with respect to the divergent outer surface 27″. Such surface 27″ may be divergent. For example in the case of the surface 27″ of each portion 33, 34 they are tilted with respect to the wall 21, 22 in an opposite manner with respect to each other.

In this manner, advantageously, the surfaces 27″ and 9 may act as a guide for the sliding of the base bar 3.

Possibly, there may be provided for a pin 3″ designed to slide in the opening 12′ so as to act as a guide for the sliding of the base bar 3. For example FIG. 33B shows the base bar 3 with a pin 3″ exiting therefrom and designed to slide in the opening 12′ of the uprights 2.

The third pair may be identical to the first and to the second pair. In other words, the profile 10 may be used for the right upright, left upright and for the base bar. In particular, such profile 10 may be obtained starting from the same half-shells 21, 22.

Thanks to such modularity, the system 1 may be particularly simple and cost-effective to manufacture, while being particularly versatile at the same time.

A gasket 4 arranged below the base bar 3 designed to remain interposed between the frame and the base bar 3 may be possibly provided for.

Upon lowering the bar 3, that is when it is in contact with the frame, the gasket may be concealed from view. For example, the base wall 23 may comprise one or more longitudinal seats 23′ designed to house such gasket 4. In this case, the gasket 4 may be a longitudinal profile

On the other hand, according to a different embodiment, the gasket 4 may have a width that is much larger than the distance of such seats 23′. In this manner, when the bar 3 is at the end-of-stroke in contact with the frame, the gasket 4 will be folded on itself, it will keep the bar slightly spaced from the frame and it will remain visible from the external.

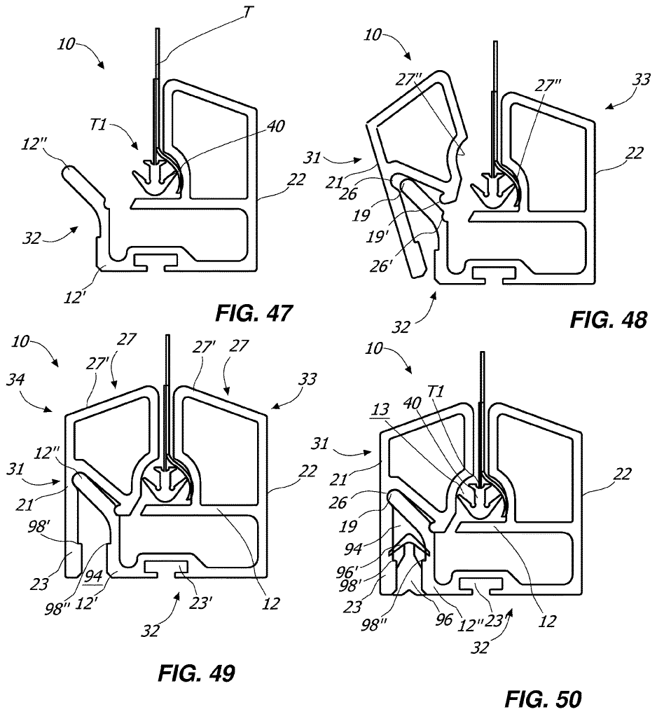

According to a particular embodiment shown in FIGS. 47-50, the profile 10 may be particularly configured to form a bar 3. In particular, such profile 10 may be configured so that the spacer 96 is not visible from the internal and/or from the external.

Suitably, as shown in FIGS. 47-50, the profile 10 may be obtained by coupling two half-shells 31 and 32 by rotation. The half-shell 32 may comprise the male protuberance 19 while the half-shell 31 may comprise the female seat 26.

Similarly to the description disclosed above, further male and female elements 19′ and 26′ may be provided for to act as an abutment.

In any case, the spacing element 96 arranged in the interspace 94 may be provided for. The latter may be formed between the area 12″ of the wall 12 of the half-shell 32 and the wall 23 of the half-shell 31.

In such embodiment, the half-shell 31 may be substantially planar while the half-shell 32 may be L-shaped. In other words, the wall 21 may comprise the wall 23.

In this case, the profile 32 may comprise the seats 23′ for the gasket 4 which may abut against the frame.

Advantageously, unlike the other embodiments shown, once fitted, the walls 21 and 22, that is the exposed side walls of the profile 10 may be continuous, that is have a continuous exposed outer surface.

In such embodiment, the chamber 11 may coincide with the seat 13. The portions 33 and 34 may therefore coincide with the protuberances 14. The inner surfaces 27″ may act as means 13′ for retaining the end T1 of the blind T. The same inner surfaces 27 may also act as abutment surfaces 16.

In particular, FIGS. 47-50 show the end T1 which comprises a fastening profile 40 positioned in the seat 13.

The profiles 10 shown in FIGS. 47-50 may therefore have the advantages described above in terms of ease of assembly by rotation and high sealing. Furthermore, they may have high resistance or a predetermined elastic strength thanks to the spacing element 96.

Lastly, the particular geometry of such half-shells 31,32 allows to obtain an aesthetically appealing profile in which the spacer 96 and the means 95 in general are at the lower portion of the profile 10. In this manner, when the bar 3 is lowered, the means 95 may be at the frame.

Thanks to this characteristic, the user may see only the walls 21 and 22 which are continuous. In general, even when the bar 3 is not in contact with the frame, the user both from the internal and from the external may substantially see only the side walls of the profile 10, which will be substantially continuous as mentioned above.

The assembly of the system 1 may be particularly simple.

For example, the half-shell 31 may be firstly provided and fasten the latter to the frame S. Subsequently, if present, an assembly 80 which may be positioned at the half-shell 31 may be provided for. In particular, it may be positioned so as to remain at the operative area 5.

Should there not be the assembly 80, the end T1 of the blind T may be directly positioned at the half-shell 31, preferably so as to remain at the operative area 5.

Subsequently, the other half-shell 32 which may be coupled with the half-shell 31 may be provided by keeping the assembly 80 or the end T1 between the two half-shells. The assembly 80 or the end T1 may therefore remain interposed between the operative areas 5 and 6, and therefore at least partially in the seat 13.

The assembly 80 may comprise the fastening element 40. Possibly, depending on the configurations, the assembly 80 may further comprise the elastic traction means 50, and/or the elastic counteracting means 70.

In the light of the above, the operator may handle one piece at a time, therefore simplifying the assembly operations. Such operation may be carried out both to form the upright 2 and to form the bar 3.

Should the system 1 be used to obtain the base bar 3, the end T1 of the blind T may be fastened to the seat 13. Even in this case, suitable fastening profiles 40 may be provided for. Preferably, the latter will be non-elastic.

For example, FIG. 42 shows an example of anchoring the lower end T1 at the base bar 3 with a rigid fastening profile 40.

Preferably, the profile 10 may comprise one or more elements 18 to increase the weight of the profile 10. Such configuration is particularly advantageous when the profile 10 is used as a base bar 3. Suitably, the operative faces 5 and 6 may be configured to support such elements 18.

According to a particular aspect of the invention, the half-shells 31, 32 may be made of metal.

Suitably, the profile 10 may have at least one outer face 8 that is continuous and, preferably, pleasant to sight.

Should there be the half-shells 31, 32, the latter may have a continuous outer face 8 and shaped opposite face 5, 6. In particular, for example as shown in FIG. 32 and FIG. 33A, the outer faces 8 of the half-shells 31, 32 may cooperate with each other to define a single substantially continuous surface of the system 1. Such continuous surface 8 may therefore confer a particularly pleasant appearance to the system 1.

It is clear that the support profiles 10, irrespective of their configuration and of the number of profiles that form them, may comprise the outer face 8, preferably a pair of substantially continuous outer faces 8.

Advantageously, the spacer element 96 may remain substantially exposed. In other words, the profile 10 may be installed so that the spacer element 96 is arranged facing outwards.

Possibly, the spacer elements 96 of the uprights and base bar may cooperate to define a single line.

The system 1 may therefore have a particular aesthetic appeal.

Furthermore, the system 1 may be mounted indistinctively from the external and from the internal, that is the spacer element 96 may be accessible from the external or from the internal. For example, as shown in FIG. 45, the spacer element 96 may remain facing toward the internal and therefore remain concealed from view.

Such characteristic is advantageous both with regard to the aesthetic appearance given that it allows the user to choose which face of the profiles 10 should remain exposed, and it is advantageous with regard to the ease of assembly for example should it not be possible to fit the system 1 from one of the two sides, for example in the case of skyscraper windows which are difficult to access from the external.

The invention is susceptible to numerous modifications and variants all falling within the inventive concept outlined in the attached claims. All details can be replaced by other technically equivalent elements, and the materials can be different depending on the technical needs, without departing from the scope of protection of the invention.

Even though the invention has been described with particular reference to the attached figures, the reference numerals used in the description and in the claims are meant for improving the intelligibility of the invention and thus do not limit the claimed scope of protection in any manner whatsoever.

1.-49. (canceled)

50. A system for anchoring a roller blind to a support structure at an opening, the system comprising:
a blind comprising a lower operating end including a fastening profile; and
an anchoring profile configured to anchor the lower end of the blind with the fastening profile so as to form a base bar defining a first axis, the anchoring profile being designed to be fastened to the support structure;
wherein the anchoring profile has a first and a second longitudinal half-shell which can be mutually coupled to each other and fastening means;
wherein the first and the second half-shell are configured to form, after coupling, a longitudinal seat for operatively anchoring the lower operating end of the blind to the fastening profile;
wherein one of the first or the second half-shell has a male or female element configured to be engaged to a corresponding male or female element of the other one of the first or the second half-shell, the male and the female element being configured so that the male and the female element are mutually engaged after the first and the second half-shell are coupled by rotation around the male and the female element;
wherein the first half-shell has a first wall comprising the male element, the other one of the first and the second half-shell having a second wall comprising the female element;
wherein the first wall and the second wall are configured so that the first and the second half-shell mutually form an interspace after coupling, the fastening means being a spacer configured to be inserted into the interspace to prevent a disengagement of the male and the female elements;
wherein the anchoring profile includes an upper portion, a lower portion, and side walls having an exposed continuous outer surface; and
wherein the spacer is at the lower portion of the longitudinal anchoring profile, so that the spacer is not visible from an outside.

51. The system according to claim 50, wherein the first wall has a first and a second end, the second end being designed to come into contact with the second wall so as to define the male element, the first end being movable between a configuration in which the first end is in contact with or proximal to the second wall and a configuration in which the first end is spaced therefrom to define the interspace.

52. The system according to claim 51, wherein the first and the second half-shell are couplable by mutual rotation, and wherein the male and the female element are configured to rotate mutually integrally joined with the first and the second half-shell between a first configuration, in which the first end is in contact with or adjacent to the second wall, and a second configuration, in which the first end is spaced therefrom to define the interspace.

53. The system according to claim 52, wherein the first and the second half-shell comprise a respective first and second contact area defining an end-of-stroke for a mutual rotation of the first and the second half-shell.

54. The system according to claim 51, wherein the interspace is formed between the first end of the first wall of the one of the first or the second half-shell and the second wall of the other of the first or the second half-shell, the other one of the first or the second half-shell being substantially planar while the one of the first or the second half-shell is L-shaped.

55. The system according to claim 50, wherein each of the first and the second half-shells comprises an operating shaped area configured so that, after coupling the first and the second half shell, the operating shaped areas cooperate to form the longitudinal seat.
